(19) United States
(12) Patent Application Publication
(10) Pub. No.: US 2019/0144646 A1
(43) Pub. Date: May 16, 2019

(54) RUBBER COMPOSITION FOR TIRES, AND PNEUMATIC TIRE USING THE SAME

(71) Applicant: Toyo Tire & Rubber Co., Ltd., Itami-shi (JP)

(72) Inventor: Souichiro Miura, Itami-shi (JP)

(73) Assignee: Toyo Tire & Rubber Co., Ltd., Itami-shi (JP)

(21) Appl. No.: 16/169,213

(22) Filed: Oct. 24, 2018

(30) Foreign Application Priority Data
Nov. 16, 2017 (JP) 2017-221189

(51) Int. Cl. C08L 9/06; C08L 7/00; C08L 53/02; C08K 5/521; B60C 1/00

(52) U.S. Cl. CPC C08L 9/06; C08L 7/00; C08L 53/02; C08K 3/04; B60C 1/0016; B60C 1/0025; C08K 5/521

(57) ABSTRACT

A rubber composition for tires is disclosed, which is capable of improving fuel efficiency, wet grip performance, and low-temperature characteristics, and also a pneumatic tire using the same. A rubber composition for tires, including, per 100 parts by mass of a rubber component, 1 to 30 parts by mass of a phosphate having a coagulation point of −50° C. or less and 1 to 20 parts by mass of a thermoplastic elastomer having a tan δ peak value of 1.5 to 2.0 and a peak-value onset temperature within a range of −20° C. to 20° C. as measured by the dynamic viscoelasticity test specified in JIS K6394 under conditions of 10 Hz frequency, 10% static strain, and 0.15% dynamic strain.

### TECHNICAL FIELD

The present invention relates to a rubber composition for tires and also to a pneumatic tire using the same.

### BACKGROUND ART

Pneumatic tires are required to not only have excellent fuel efficiency but also be excellent in grip performance on a wet road that is, wet grip performance. However, these characteristics contradict each other, and thus it is not easy to improve them at the same time. In addition, at low temperatures, the elastic modulus of a rubber composition increases, resulting in a decrease in grip performance. Therefore, in winter tires, there are also problems with low-temperature characteristics.

As a tire capable of reducing the rolling resistance, that is, capable of improving fuel efficiency, of a tire tread without impairing other properties, particularly wet grip characteristics, PTL 1 discloses a tire characterized in that the tread includes a rubber composition containing at least one kind of diene elastomer, at least one kind of reinforcing filler, and more than 10 phr of a hydrogenated styrene thermoplastic (“TPS”) elastomer.

However, PTL 1 is silent as to low-temperature characteristics, and there still is room for further improvement in fuel efficiency, wet grip performance, and low-temperature characteristics.

### CITATION LIST

### Patent Literature

[PTL 1] JP-T-2013-510939 (the term “JP-T” as used herein means a published Japanese translation of a PCT patent application)
[PTL 2] JP-A-2014-189698
[PTL 3] JP-A-2015-110703
[PTL 4] JP-A-2015-110704

### SUMMARY OF THE INVENTION

### Problems That the Invention is to Solve

In light the above points, an object of the invention is to provide a rubber composition for tires, which is capable of improving fuel efficiency, wet grip performance, and low-temperature characteristics, and also a pneumatic tire using the same.

Incidentally, in PTLs 2 to 4, for the purpose of improving grip performance, a rubber composition blended with a hydrogenated thermoplastic elastomer is disclosed. However, they are silent as to fuel efficiency and low-temperature characteristics.

### Means for Solving the Problems

In order to solve the above problems, the rubber composition for tires according to the invention includes, per 100 parts by mass of a rubber component, 1 to 30 parts by mass of a phosphate having a coagulation point of −50° C. or less and 1 to 20 parts by mass of a thermoplastic elastomer having a tan δ peak value of 1.5 to 2.0 and a peak-value onset temperature within a range of −20° C. to 20° C. as measured by the dynamic viscoelasticity test specified in JIS K6394 under conditions of 10 Hz frequency, 10% static strain, and 0.15% dynamic strain.

It is possible that the thermoplastic elastomer is a block copolymer having polystyrene as a hard segment.

It is possible that the thermoplastic elastomer is a block copolymer having hydrogenated polydiene as a soft segment.

The pneumatic tire according to the invention is produced using the above rubber composition for tires.

### Advantage of the Invention

The rubber composition for tires of the invention makes it possible to obtain a pneumatic tire having improved fuel efficiency, wet grip performance, and low-temperature characteristics.

### MODE FOR CARRYING OUT THE INVENTION

Hereinafter, matters relevant to the practice of the invention will be described in detail.

A rubber composition for tires according to this embodiment includes, per 100 parts by mass of a rubber component, 1 to 30 parts by miss of a phosphate having a coagulation point of −50° C. or less and 1 to 20 parts by mass of a thermoplastic elastomer haying a tan δ peak value of 1.5 to 2.0 and a peak-value onset temperature within a range of −20° C. to 20° C. as measured by the dynamic viscoelasticity test specified in JIS K6394 under conditions of 10 Hz frequency, 10% static strain, and 0.15% dynamic strain. Incidentally, for use in the dynamic viscoelasticity test, a thermoplastic elastomer is formed into a 2-mm-thick sheet by a roller, then vulcanized at 160° C. for 30 minutes, punched into a strip-shaped dumbbell of 5 mm in width and 20 mm in length, and used.

The rubber component according to this embodiment is not particularly limited. Examples thereof include a natural rubber (NR), an isoprene rubber (IR), a butadiene rubber (BR), styrene-butadiene rubber (SBR), as styrene-isoprene copolymer rubber, a butadiene-isoprene copolymer rubber, and a styrene-isoprene-butadiene copolymer rubber. These diene rubbers may be used alone, and it is also possible to use a blend of two or more kinds.

The phosphate according to this embodiment is not particularly limited as long as it has a coagulation point of −50° C. or less. For example, tris(2-ethylhexyl) phosphate (TOP), triethyl phosphate (TEP), and the like may be used. When a phosphate having a coagulation point of −50° C. or less is used, excellent fuel efficiency and low-temperature characteristics are likely to be obtained. Here, the coagulation point of a phosphate is a value measured using a differential scanning calorimeter (DSC-60A manufactured by Shimadzu Corporation). Specifically, a phosphate was hermetically sealed in an aluminum cell and inserted into a sample holder, then, while heating the sample holder from −100° C. to 25° C. at 20 K/min in a nitrogen atmosphere, the difference in the amount of heat from the standard substance was measured, and the temperature at which the endothermic peak was observed was defined as the coagulation point.

The content of the phosphate is 1 to 30 parts by mass, preferably 1 to 20 parts by mass, and more preferably 5 to 20 parts by mass per 100 parts by mass of the cribber component. When the content is 1 to 30 parts by mass, excellent fuel efficiency and low-temperature characteristics are likely to be obtained.

The thermoplastic elastomer according to this embodiment has a tan δ peak value of 1.5 to 2.0 and a peak-value onset temperature within a range of −20° C. to 20° C. as measured by the dynamic viscoelasticity test specified in JIS K6394 under conditions of 10 Hz frequency, 10% static strain, and 0.15% dynamic strain. As such a thermoplastic elastomer, from commercially available thermoplastic elastomers, one haying a tan δ peak value and a peak-value onset temperature satisfying the above ranges may be selected. Specific examples thereof include “S.O.E.S 1605” manufactured by Asahi Kasei Corporation and “HYBRAR 7125” manufactured by Kuraray Co., Ltd.

The thermoplastic elastomer is preferably a styrenic thermoplastic elastomer having polystyrene as a hard segment, and more preferably a hydrogenated styrenic thermoplastic elastomer having a hydrogenated polydiene as a soft segment. Examples of hydrogenated polydienes include a hydrogenated polyisoprene, a hydrogenated polybutadiene, and a hydrogenated styrene butadiene copolymer. That is, it is particularly preferably that the thermoplastic elastomer is a thermoplastic elastomer having polystyrene as a hard segment and at least one member selected from the group consisting a hydrogenated polyisoprene, a hydrogenated polybutadiene, and a hydrogenated styrene/butadiene copolymer as a soft segment.

In the case where the thermoplastic elastomer is a styrenic thermoplastic elastomer, the tan δ peak value increases with a decrease in molecular weight. In addition, the peak-value onset temperature increases with an increase in styrene content and decreases with a decrease in styrene content. Therefore, it is also possible to use a thermoplastic elastomer prepared by adjusting the molecular weight and the styrene content to make the tan δ peak value and the peak-value onset temperature within the above ranges.

In the case where the thermoplastic elastomer is a styrenic thermoplastic elastomer, its styrene content is not particularly limited, but is preferably 15 to 40 mass %, and more preferably 20 to 35 mass %.

The content of the thermoplastic elastomer is not particularly limited, but is preferably 1 to 20 parts by mass, more preferably 5 to 20 parts by mass, and still more preferably 5 to 15 parts by mass per 100 parts by mass of the rubber component.

In the rubber composition according to this embodiment, carbon black and/or silica may be used as a reinforcing filler. That is, the reinforcing filler may be carbon black alone, silica alone, or a combination of carbon black and silica. A combination of carbon black and silica is preferable. The content of the reinforcing filler is not particularly limited, and is, for example, preferably 20 to 120 parts by mass, more preferably 20 to 100 parts by mass, and still more preferably 30 to 80 parts by mass per 100 parts by mass of the rubber component.

Carbon black is not particularly limited, and various known species may be used. The content of carbon black is preferably 1 to 70 parts by mass, more preferably 1 to 30 parts by mass, per 100 parts by mass of the rubber component.

Silica is not particularly limited either, but it is preferable to use wet silica, such as wet-precipitated silica or wet-gelled silica. In the case where silica is contained, in terms of the balance of tan δ of the rubber, the reinforcing properties, and the like, the content thereof is preferably 10 to 100 parts by mass, more preferably 15 to 70 parts by mass, per 100 parts by mass of the rubber component.

In the case where silica is contained, silane coupling agents, such as sulfide silane and mercapto silane, may further be contained. In the case where a silane coupling agent is contained, the content thereof is preferably 2 to 20 parts by mass per 100 parts by mass of silica.

In the rubber composition according to this embodiment, in addition to the components described above, formulated chemicals used in the usual rubber industry, such as process oils, zinc oxide, stearic acid, softeners, plasticizers, waxes, antioxidants, vulcanizers, and vulcanization accelerators, can be suitably blended within the usual range.

Examples of vulcanizers include sulfur components such as powder sulfur, precipitated sulfur, colloidal sulfur, insoluble sulfur, and highly dispersed sulfur. The vulcanizer content is preferably 0.1 to 10 parts by mass, more preferably 0.5 to 5 parts by mass, per 100 parts by mass of the rubber component. In addition, the vulcanization accelerator content is preferably 0.1 to 7 parts by mass, more preferably 0.5 to 5 parts by mass, per 100 parts by mass of the rubber component.

The rubber composition according to this embodiment can be produced by kneading in the usual manner using a mixer that is usually used, such as a Banbury mixer, a kneader, or a roll. That is, in the first mixing stage, a phosphate, a thermoplastic elastomer, and also other additives excluding a vulcanizer and a vulcanization accelerator are added to a rubber component and mixed, and, in the final mixing stage, a vulcanizer and a vulcanization accelerator are added to the obtained mixture and mixed, whereby the rubber composition can be prepared.

The rubber composition obtained in this manner can be used for tires. The rubber composition is applicable to various parts of a tire, such as the tread part and the side wall part of pneumatic tires of various sizes for various applications, including automotive tires, large tires for trucks and buses, etc. A pneumatic tire can be produced by forming the rubber composition into a predetermined shape in the usual manner, such as by extrusion, and then combining with other parts, followed by vulcanization molding at 140 to 180°C., for example.

The kind of pneumatic tire according to this embodiment is not particularly limited. Examples thereof include, as described above, various tires such as automotive tires and heavy-load tires for trucks and buses.

### EXAMPLES

Hereinafter, examples of the invention will be shown, but the invention is not limited to these examples.

### Examples and Comparative Examples

Using a Banbury mixer, following the formulation (part by mass) shown in Table 1 below, first, in the first mixing stage (non processing kneading step), components excluding a vulcanization accelerator and sulfur were added and mixed (discharge temperature=160° C.), and, in the final mixing stage (processing kneading step), a vulcanization accelerator and sulfur were added to the obtained mixture and mixed (discharge temperature=90°C.), thereby preparing a rubber composition.

The details of the components in Table 1 are as follows.
SBR: “VSL5025-01” manufactured by LANXESS
BR: “BR150B” manufactured by Ube Industries, Ltd.
   Thermoplastic Elastomer 1: “S.O.E.S 1605” manufactured by Asahi Kasei Corporation, styrene-hydrogenated styrene/butadiene-styrene block copolymer, tan δ peak value 1.58, peak-value onset temperature: 18° C., number average molecular weight: 1.12×10⁵, weight average molecular weight: 2.18×10⁵
   Thermoplastic Elastomer 2: “HYBRAR 7125” manufactured by Kuraray Co., Ltd., styrene-hydrogenated isoprene-styrene block copolymer, tan δ peak value: 1.84, peak-value onset temperature: −6° C.
   Thermoplastic Elastomer 3: “S.O.E.S 1611” manufactured by Asahi Kasei Corporation, styrene-hydrogenated styrene/butadiene-styrene block copolymer, tan δ peak value: 0.83, peak-value onset temperature: 9° C., number average molecular weight 1.34×10⁵, weight average molecular weight 1.70×10⁵
   Thermoplastic Elastomer 4: “Tuftec H1062” manufactured by Asahi Kasei Corporation, styrene-hydrogenated ethylene/butylene-styrene block copolymer, tan δ peak value: 0.86, peak-value onset temperature: −47° C.
   Phosphate 1: Tris(2-ethylhexyl) phosphate (TOP) manufactured by Daihachi Chemical Industry Co., Ltd., coagulation point: −70° C. or less
   Phosphate 2: Methyl phosphate (TEP) manufactured by Daihachi Chemical Industry Co., Ltd., coagulation point: −56° C.
   Phosphate 3: Trixylenyl phosphate (TXP) manufactured by Daihachi Chemical Industry Co., Ltd., coagulation point: −15° C.
Silica: “Nipsil AQ” manufactured by Tosoh Silica Corporation
   Carbon black: “DIABLACK N341” manufactured by Mitsubishi Chemical Corporation
Silane coupling agent: “Si69” manufactured by Evonik
Oil: “Process NC140” manufactured by JX Energy
Zinc oxide: “Zinc Oxide No. 1” manufactured by Mitsui Mining & Smelting Co., Ltd.
Antioxidant: “Antigen 6C” manufactured by Sumitomo Chemical Co., Ltd.
Stearic acid: “LUNAC S-20” manufactured by Kao Corporation
Wax: “OZOACE0355” manufactured by Nippon Seiro Co., Ltd.
   Sulfur: “5% OIL TREATED SULFUR POWDER” manufactured by Tsurumi Chemical Industry Co., Ltd
   Vulcanization Accelerator 1: “SOXINOL CZ” manufactured by Sumitomo Chemical Co., Ltd.
   Vulcanization Accelerator 2: “Nocceler D” manufactured by Ouchi Shinko Chemical Industrial Co., Ltd.

The tan δ peak value and the peak-value onset temperature of each thermoplastic elastomer described above are values obtained by measuring the loss factor tan δ using a viscoelasticity tester manufactured by Toyo Seiki Co., Ltd., at a temperature within a range of −60° C. to 100° C. in accordance with JIS K6394. The measurement conditions were as follows: frequency: 10 Hz, static strain: 10%, dynamic strain: 0.15%. Incidentally, as a sample piece, a thermoplastic elastomer was formed into a 2-mm-thick sheet by a roller, then vulcanized at 160° C. for 30 minutes, punched into a strip-shaped dumbbell of 5 mm in width and 20 mm in length, and used.

The coagulation point of each phosphate described above was measured as follows. Using a differential scanning calorimeter (DSC-60A manufactured by Shimadzu Corporation), a phosphate was hermetically sealed in an aluminum cell and inserted into a sample holder, and then, while heating the sample holder from −100° C. to 25° C. at 20 K/min in a nitrogen atmosphere, the difference in the amount of heat from the standard substance was measured. The coagulation point is the temperature at which the endothermic peak was thus observed.

The wet grip performance, fuel efficiency, and low-temperature characteristics of each obtained rubber composition were evaluated. The evaluation methods are as follows.
Wet Grip Performance: Using a specimen of a predetermined shape prepared by vulcanizing the obtained rubber composition at 160° C. for 30 minutes, the loss factor tan δ was measured as the value using a viscoelasticity tester manufactured by Toyo Seiki Co., Ltd., in accordance with JIS K6394. The measurement conditions were as follows: frequency: 10 Hz, static strain: 10%, dynamic strain: 1%, temperature: 0° C. The result was expressed as an index taking the value of Comparative Example 1 as 100. A larger index indicates better wet grip performance.
Fuel Efficiency: Using a specimen of a predetermined shape prepared by vulcanizing the obtained rubber composition at 160° C. for 30 minutes, the loss factor tan δ was measured as the value using a viscoelasticity tester manufactured by Toyo Seiki Co., Ltd., in accordance with JIS K6394. The measurement conditions were as follows: frequency: 10 Hz, static strain: 10%, dynamic strain: 1%. temperature: 60° C. The result was expressed as an index taking the value of Comparative Example 1 as 100. A smaller index indicates better fuel efficiency.
Low-temperature characteristics: Using a specimen of a predetermined shape prepared by vulcanizing the obtained rubber composition at 160° C. for 30 minutes, the loss factor tan δ was measured as the value using a viscoelasticity tester manufactured by Toyo Seiki Co., Ltd., in accordance with JIS K6394. The measurement conditions were as follows: frequency: 10 Hz, static strain: 10%, dynamic strain: 1%, temperature: −15° C. The result was expressed as an index taking the value of Comparative Example 1 as 100. A smaller index indicates better low-temperature characteristics.

TABLE 1

| | Compar- | Compar- | | | | | | |
|---|---|---|---|---|---|---|---|---|
| | ative | ative | Comparative | Comparative | Comparative | Comparative | Comparative | Comparative |
| | Example 1 | Example 2 | Example 3 | Example 4 | Example 5 | Example 6 | Example 7 | Example 8 |
| SBR | 70 | 70 | 70 | 70 | 70 | 70 | 70 | 70 |
| BR | 30 | 30 | 30 | 10 | 30 | 30 | 30 | 30 |
| Thermoplastic Elastomer 1 | — | — | 10 | — | — | — | — | 10 |
| Thermoplastic Elastomer 2 | — | — | — | — | — | — | — | — |
| Thermoplastic Elastomer 3 | — | — | — | 10 | — | 10 | — | — |
| Thermoplastic Elastomer 4 | — | — | — | — | 10 | — | 10 | — |
| Phosphate 1 | — | 10 | — | — | — | 10 | 10 | — |
| Phosphate 2 | — | — | — | — | — | — | — | — |
| Phosphate 3 | — | — | — | — | — | — | — | 10 |
| Silica | 70 | 70 | 70 | 70 | 70 | 70 | 70 | 70 |
| Carbon black | 10 | 10 | 10 | 10 | 10 | 10 | 10 | 10 |
| Silane coupling agent | 7 | 7 | 7 | 7 | 7 | 7 | 7 | 7 |
| Oil | 20 | 10 | 20 | 20 | 20 | 10 | 10 | 10 |
| Zinc oxide | 3.0 | 3.0 | 3.0 | 3.0 | 3.0 | 3.0 | 3.0 | 3.0 |
| Antioxidant | 2.0 | 2.0 | 2.0 | 2.0 | 2.0 | 2.0 | 2.0 | 2.0 |
| Stearic acid | 2.0 | 2.0 | 2.0 | 2.0 | 2.0 | 2.0 | 2.0 | 2.0 |
| Wax | 2.0 | 2.0 | 2.0 | 2.0 | 2.0 | 2.0 | 2.0 | 2.0 |
| Sulfur | 1.5 | 1.5 | 1.5 | 1.5 | 1.5 | 1.5 | 1.5 | 1.5 |
| Vulcanization Accelerator 1 | 1.8 | 1.8 | 1.8 | 1.8 | 1.8 | 1.8 | 1.8 | 1.8 |
| Vulcanization Accelerator 2 | 2.0 | 2.0 | 2.0 | 2.0 | 2.0 | 2.0 | 2.0 | 2.0 |
| Wet grip performance | 100 | 96 | 106 | 104 | 98 | 98 | 100 | 117 |
| Fuel efficiency | 100 | 84 | 110 | 108 | 102 | 96 | 94 | 106 |
| Low-temperature | 100 | 88 | 110 | 112 | 105 | 95 | 95 | 102 |
| characteristics | | | | | | | | |

| | Example 1 | Example 2 | Example 3 | Example 4 | Example 5 | Example 6 |
|---|---|---|---|---|---|---|
| SBR | 70 | 70 | 70 | 70 | 70 | 70 |
| BR | 30 | 30 | 30 | 30 | 30 | 30 |
| Thermoplastic Elastomer 1 | 5 | 10 | — | — | — | — |
| Thermoplastic Elastomer 2 | — | — | 10 | 10 | 10 | 10 |
| Thermoplastic Elastomer 3 | — | — | — | — | — | — |
| Thermoplastic Elastomer 4 | — | — | — | — | — | — |
| Phosphate 1 | 10 | 10 | 10 | — | — | — |
| Phosphate 2 | — | — | — | 5 | 10 | 20 |
| Phosphate 3 | — | — | — | — | — | — |
| Silica | 70 | 70 | 70 | 70 | 70 | 70 |
| Carbon black | 10 | 10 | 10 | 10 | 10 | 10 |
| Silane coupling agent | 7 | 7 | 7 | 7 | 7 | 7 |
| Oil | 10 | 10 | 10 | 15 | 10 | — |
| Zinc oxide | 3.0 | 3.0 | 3.0 | 3.0 | 3.0 | 3.0 |
| Antioxidant | 2.0 | 2.0 | 2.0 | 2.0 | 2.0 | 2.0 |
| Stearic acid | 2.0 | 2.0 | 2.0 | 2.0 | 2.0 | 2.0 |
| Wax | 2.0 | 2.0 | 2.0 | 2.0 | 2.0 | 2.0 |
| Sulfur | 1.5 | 1.5 | 1.5 | 1.5 | 1.5 | 1.5 |
| Vulcanization Accelerator 1 | 1.8 | 1.8 | 1.8 | 1.8 | 1.8 | 1.8 |
| Vulcanization Accelerator 2 | 2.0 | 2.0 | 2.0 | 2.0 | 2.0 | 2.0 |
| Wet grip performance | 108 | 118 | 115 | 114 | 116 | 114 |
| Fuel efficiency | 88 | 94 | 92 | 96 | 93 | 88 |
| Low-temperature | 92 | 95 | 94 | 97 | 94 | 90 |
| characteristics | | | | | | |

The results are as shown in Table 1. A comparison between Examples 1 to 6 and Comparative Examples 1 to 8 shows that when a predetermined thermoplastic elastomer and a predetermined phosphate are used together, the wet grip performance, fuel efficiency, and low-temperature characteristics are improved.

### INDUSTRIAL APPLICABILITY

The rubber composition for tires of the invention can be user for various tires for automobiles, light trucks, buses, and the like.

1. A rubber composition for tires, comprising, per 100 parts by mass of a rubber component:
1 to 30 parts by mass of a phosphate having a coagulation point of −50° C. or less; and
1 to 2.0 parts by mass of a thermoplastic elastomer having a tan δ peak value of 1.5 to 2.0 and a peak-value onset temperature within a range of −20° C. to 20° C. as measured by the dynamic viscoelasticity test specified in JIS K6394 under conditions of 10 Hz frequency, 10% static strain, and 0.15% dynamic strain.

2. The rubber composition for tires according to claim 1, wherein the thermoplastic elastomer is a block copolymer having polystyrene as a hard segment.

3. The rubber composition for tires according to claim 1, wherein the thermoplastic elastomer is a block copolymer having hydrogenated polydiene as a soft segment.

4. The rubber composition for tires according to claim 2, Wherein the thermoplastic elastomer is a block copolymer having hydrogenated polydiene as a soft segment.

5. A pneumatic tire produced using the rubber composition for tires according to claim 1.

6. A pneumatic tire produced using the rubber composition for tires according to claim 2.

7. A pneumatic tire produced using the rubber composition for tires according to claim 3.

8. A pneumatic tire produced using the rubber composition for tires according to claim 4.
